(19) United States
(12) Patent Application Publication
(10) Pub. No.: US 2018/0139156 A1
(43) Pub. Date: May 17, 2018

(54) Computer System

(71) Applicant: Microsoft Technology Licensing, LLC, Redmond, WA (US)

(72) Inventors: Rajiv Kumar, Hyderabad (IN); Deepak Pratinidhi, Hyderabad (IN); Arun Rajappa, Hyderabad (IN); Rakesh Midha, Hyderabad (IN); Dharmanand Singh, Hyderabad (IN); Vikrant Deepak Shah, Hyderabad (IN); Teekam Chand Goyal, Hyderabad (IN)

(73) Assignee: Microsoft Technology Licensing, LLC, Redmond, WA (US)

(21) Appl. No.: 15/583,626

(22) Filed: May 1, 2017

(30) Foreign Application Priority Data
Nov. 17, 2016 (IN) 201641039309

(51) Int. Cl. H04L 12/58; H04L 29/08; H04L 29/06; G06Q 10/10

(52) U.S. Cl. CPC H04L 51/046; H04L 67/306; H04L 63/08; G06Q 10/103; H04L 65/403

(57) ABSTRACT

A messaging system with messaging accounts for users of the messaging system comprises a group messaging service for transmitting and receiving messages via a network between users in each of plurality of messaging groups, those users having messaging accounts associated with that messaging group. An organization management system with member accounts for members of an organization comprises a registration service for registering user identifiers with the member accounts. An information retrieval service of the organization management system generates a group information request comprising a user identifier registered with one of the member accounts. A system interface communicates to the organization management system, in response, information about at least one of the messaging groups associated with a corresponding one of the messaging accounts comprising a matching user identifier.

### RELATED MATTERS

This application claims priority under 35 U.S.C. 119 or 365 to India Application No. 201641039309 filed Nov. 17, 2016, the disclosure of which is hereby incorporated by reference in its entirety.

### TECHNICAL FIELD

The present invention pertains to a computer system comprising a messaging system, a second system, and a system interface for communicating information between those systems.

### BACKGROUND

A messaging (chat) system allows users of the messaging system to exchanges messages with other uses of the messaging system. The messages are primarily text-based, but can also comprise rich content such as images, videos, documents, audio etc. This is sometimes referred to as instant messaging, which refers to the fact that the messaging takes place in real time. That is, there is typically only a short delay (e.g. about two seconds or less) between a user sending a message and it being received by its intended recipient(s). The messages are transmitted and received via a network, for example a packet-based network such as the Internet.

Other rich functionality, such as collaborative documents editing, poll creation etc. may also be provided within the messaging system.

The users have messaging accounts held within the messaging system and which they use to access the messaging system.

Within the messaging system, users may be able to create messaging groups. Multiple users, often more than two users, may be participants in a messaging group. The participant's messaging accounts are associated with the messaging group, which provides a convenient means by which those users can communicate with each other using a messaging service of the messaging system. For example, the messaging service may comprise a messaging server which relays messages between users in the group, or a look up server which allows network addresses of the users to be obtained so that messages can be sent between them directly etc.

### SUMMARY

A first aspect of the present invention is directed to a computer system comprising: a messaging system comprising: (i) first computer storage holding messaging accounts for users of the messaging system, and (ii) a group messaging service configured for use in transmitting and receiving messages via a network between users in each of plurality of messaging groups, those users having messaging accounts associated with that messaging group in the first computer storage; an organization management system comprising: (i) second computer storage holding member accounts for members of an organization, and (ii) a registration service for registering user identifiers (IDs) with the member accounts in the second computer storage; and a system interface for communicating information between the messaging system and the organization management system; wherein an information retrieval service of the organization management system is configured to generate a group information request comprising a user identifier registered with one of the member accounts; and wherein the system interface is configured to communicate to the organization management system, in response to the group information request, information about at least one of the messaging groups associated with a corresponding one of the messaging accounts comprising a matching user identifier.

Herein, a messaging account in the messaging system is said to correspond to a member account in the organization management system when a user identifier registered with the member account in the organization management system matches a user identifier in the messaging account of the messaging system. The user identifier can for example be a telephone number, email address etc.

In embodiments, the messaging system may be configured to provide an authentication function for authenticating users of the messaging system based on user credential information in the messaging accounts, wherein the organization management system is configured to provide a separate and independent authentication function for authenticating users of the organization management system based on user credential information in the member accounts.

For example, the authentication function of the messaging system may validate a user against one of the messaging accounts by comparing credential information provided by the user with the credential information contained in the messaging account. If the provided information matches that in the messaging account, in response the user is authorized to use the messaging account.

The authentication function of the organization management system may, separately and independently, validate the user against one of the member accounts by comparing credential information provided by the user with the credential information contained in the member account. If the provided information matches that in the member account, in response the user is authorized to use the member account.

A different one of the member accounts may be configured as an organisation administrator account in the second computer storage. An information access service of the organization management system may be configured to grant, to an authorised user of the organisation administrator account, access to the messaging group information retrieved for the member account.

The information access service may be configured to: communicate to an authorized user of the member account the group messaging information retrieved for the messaging group, receive from the user of the member account a grant of access for the messaging group, wherein said access to the messaging group information may be granted to the user of the organization administrator account in response.

The organization administrator account may be associated with an organization identifier in the second computer storage, and the grant of access may associate the messaging group with that organization identifier in the second computer storage, thereby granting said access to the user of the organization administrator account.

The user of the organisation administrator account may be granted access to messaging group information retrieved from the messaging system for a plurality of messaging groups, each associated with a messaging account in the messaging system corresponding to a member account in the organization management system. That is, a respective user identifier is registered with the corresponding member account that matches a user identifier in that messaging account.

Each of the plurality of messaging groups may be associated with the organization identifier in the organization management system, thereby granting the user of the organisation administrator account (org admin) access to the information about those messaging groups. That is, the org admin is granted access to all retrieved group messaging information associated with the same organization ID as his account, which may be collected across multiple messaging and member accounts.

The information access service may be configured to cause a display accessible to an authorized user of the member account to display the group messaging information retrieved for the corresponding messaging account. More generally, any of the information communicated to that user can be displayed on the display.

The communication, by the system interface, of the information about the messaging group associated with the corresponding messaging account may be conditional on that messaging account being assigned a group administrator role for the messaging group within the messaging system. That is, users may only be able to import information into the organization management system form the messaging system for messaging groups in which they are a group administrator.

The user identifier may comprise a telephone number and/or an email address.

The information retrieval service may be configured to: retrieve messaging group information from the messaging system for at least two of the member accounts in the second computer storage of the organization management system, determine therefrom that corresponding messaging accounts in the first computer storage of the messaging system are associated with the same messaging group.

The at least two member accounts may be associated with the same messaging group in the messaging system such that duplicate information is communicated to the organization management system for that messaging group by the system interface, wherein the organization management system may be configured to detect and remove the duplicate information. For example, to determine a set of unique messaging groups associated with the organization ID.

The retrieved information may comprise a messaging group identifier for the messaging group.

The retrieved information may comprise message data exchanged between the users of the messaging system in the messaging groups and/or at least one metric pertaining to the exchanged message data.

### BRIEF DESCRIPTION OF FIGURES

For a better understanding of the present invention, and to show how embodiments of the same may be carried into effect, reference is made to the following figures in which:

FIG. 1 shows a schematic block diagram of a computer system;

FIG. 2 shows a schematic functional block diagram for a messaging system and organization management system;

FIG. 3 illustrates a mechanism for sharing information between a messaging system and an organization management system;

FIGS. 4 and 5 show a highly schematic examiner of relationships between groups and organizations; and

FIG. 6 illustrates an example use-case.

### DETAILED DESCRIPTION

The described embodiments provide dynamic linking of chat (messaging) groups, created within a messaging system, to an organization (org) managed by a separate and independent an organization management system (organisational system/org subscription system), such as Office 365 (O365), to provide various function such as correlated computing and analysis.

This enables large organizations (e.g. corporations, governments etc.) to manage and organise smaller groups of users that align to a department and who have already created a conversational group of users, which have in excess of tens of thousands of users.

Users of the messaging system form messaging groups. Some groups may be personal and some will relate to business, e.g. a department or operational group or an organization. Each user's identity is associated with a user identifier, such as phone number.

An administrator of the organisation uses a web portal linked to the messaging system service to upload organisational information about the organisation from the messaging system to the organization system, using a system interface between the systems (for example this may be via an O365 export relating to a hierarchical org structure). The organisational system has a phone number associated with each member of the organisation, so the messaging system can identify the accounts associated with the users in the organisation.

The administrator/system can manually/automatically associate the pre-existing user groups including members of the organisation to their place in the hierarchical organisation structure.

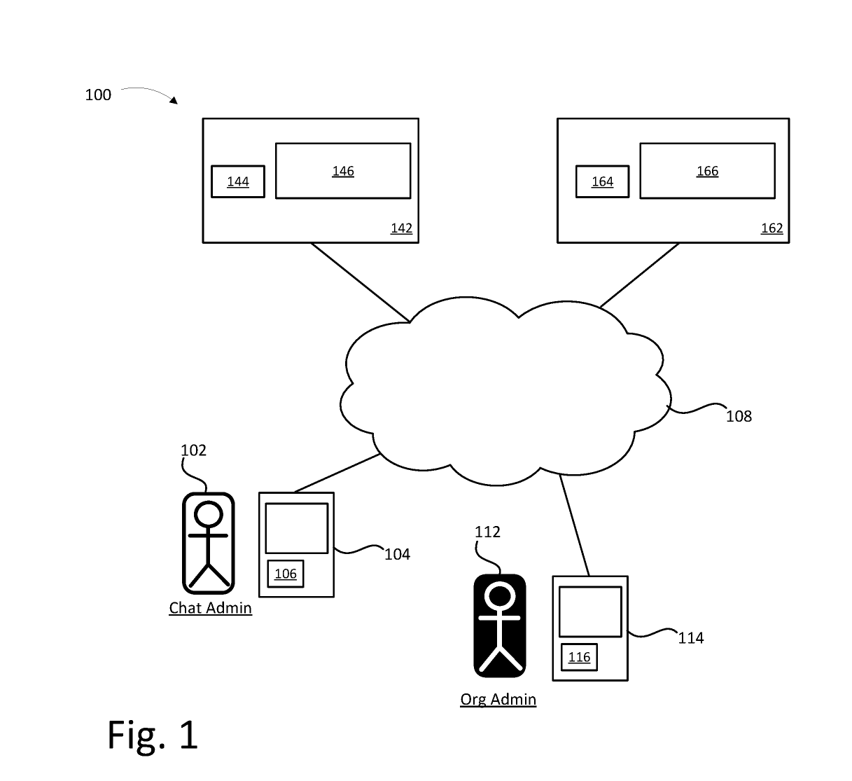

FIG. 1 shows a highly schematic block diagram of a computer system 100 comprising a messaging system 142, an organizational system 162 and first and second user devices 104, 144 operated by first and second users 102, 112 respectively. The systems and devices 104, 114, 142, 162 are shown connected to a network 108, which is a packet-based computer network such as the Internet.

The user devices 104, 114 comprise respective processors 106, 116, such as a Computer Processing Unit (CPU) or CPUs, for executing instructions stored in memory of the user device 104/114 (not shown) so as to carry out functions embodies in those instructions.

The processor 106 of the first user device is configured to execute at least two applications: a messaging application and a management application (not shown), which comprise respective instructions that when executed on the processor 106 cause the user device 104 to establish respective connections via the network 108 with the messaging system 142 and organizational system 162 respectively, thereby allowing the user 102 to access services provided by those systems from his user device 104. The user 102 is a chat administrator (group administrator) within the messaging system 142, the significance of which will become apparent in due course.

The processor 116 of the second user device 114 is configured to execute an instance of the management application so that the user 112, who is an organization administrator within the organizational system 162, can access services provided by the organizational system 162 at least, via the network 108.

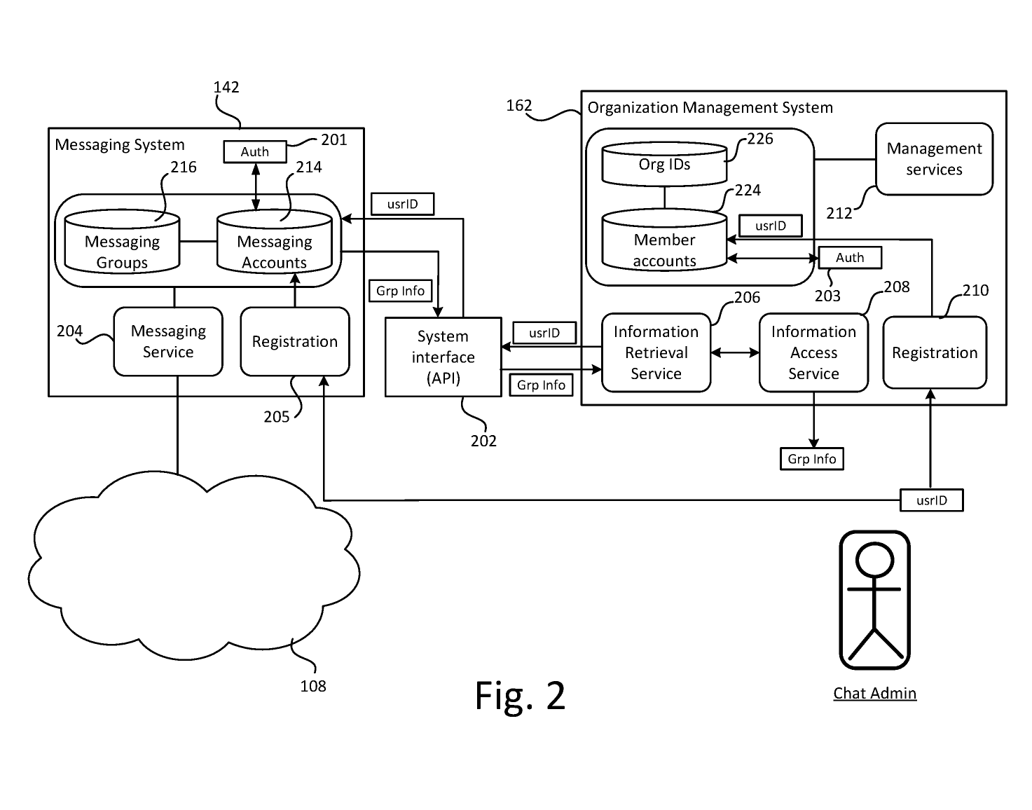

The messaging system 142 comprises at least one processor 144, such as a CPU or CPUs, and first computer storage 146 accessible to the at least one processor 144. The at least one processor 144 is configured to execute message system code (not shown) stored in the first computer storage 146 in order to implement the functionality of the messaging system 142 that is described below. In particular, the messaging code implements, when executed, a messaging service (204, FIG. 2) and a registration service (205, FIG. 2) that are described later.

The organizational system 162 also comprises at least one processor 164, such as a CPU or CPUs, and second computer storage 166 accessible to the at least one processor 164. The at least one processor 164 is configured to execute management code (not shown) stored in the second computer storage 166 in order to implement the functionality of the organizational system 162 described below. In particular, the management code, when executed, implements an information retrieval service, an information access service, a registration service and one or more organization management services (FIGS. 2: 206, 208, 210 and 212 respectively).

The user devices 104, 114 also comprise respective displays (not shown) which can be controlled to display information communicated to the devices by the systems 142, 162, thereby outputting that information to the user 102/112 in question.

The computer system 100 also comprises a system interface 202, which is not shown in FIG. 1 but is shown in FIG. 2. The system interface comprises any suitable arrangement of hardware and/or software that is configured to allow communication between the systems 142, 162. The system interface 202 can for example be an application programming interface (API). That is, interface software executed on at least one processor that provides, when executed, at least one communication function that can be instantiated to communicate desired information between the systems 142, 162.

The org subscription system 162 is separate from the messaging system 142, and is operated and managed independently. It has a provision (registration service 210—see below) for setting up org accounts Member accounts 224 with separate roles such as org admins (112) and chat group admins (102). User authentication for this system 162 remains flexible, independent of the chat system 142.

That is, the messaging system 142 and the organizational system 162 have separate and independent authentication functions—201,203 respectively—for authenticating users based on their messaging accounts 214 and member accounts 224 respectively. By successfully authenticating himself, the user becomes the authorized user of that account. The messaging accounts 214 and member accounts 224 are also created and managed independently, by registration services 205 and 210 respectively.

Each chat group 102 admin maps and verifies their mobile number (or other user identifier) with his member account in the organizational system 162. Chat groups for the chat admin 102 are pulled from the messaging system 142 and mapped to the org. Chat group admin 102 has the flexibility to remove any groups from the tenant (i.e. the organization). Group admins 102 can manage and view data for chat groups that they are admin for. Org admin 112 can manage and view data for all chat groups mapped with the org.

With reference to FIG. 2, the two systems 142, 162 have independent user account infrastructure, wherein users can create separate and independent user accounts with the two systems.

Within the messaging system 142, user accounts 214 are created and stored in the first computer storage 146. User accounts within the messaging system 142 are referred to as messaging accounts. Each messaging account 214 comprises user data of its user, such as a user credential(s) and other information pertaining to the user in the context of the messaging system 142. The messaging accounts 214 are created by the registration service 205 of the messaging system 142, which can for example provide a Web interface via which a user can create a messaging account using an instance of the messaging application executed on his user device, such as devices 104/114.

Within the organizational system 162, user accounts 224 are created and stored in the second computer storage 166. User accounts in the organizational system 162 are referred to as member accounts, belonging as they do to members of an organization managed by the system 162. The member accounts 224 are created by the registration service 210 of the organizational system 162, which can for example provide a Web interface for creating messaging accounts, using the management application, for example on device 114.

The messaging service 204 of the messaging system 142 allows authorized users of the messaging accounts 214 to transmit instant messages to and receive instant messages from other users of the messaging system. The messaging service 204 also allows those users to create messaging groups 216. Information about each messaging groups 216, such as a group identifier (grpID) and information about the users participating in that messaging group, is stored in the first computer storage 146. The messaging accounts 214 of users participating in a messaging group are associated with the messaging group (that is, with the group ID of that messaging group) in the first computer storage 146. Based on this group information and the information in the associated messaging accounts 214, the messaging service 204 allows the group participants to exchange instant messages within the messaging group via the network 108. For example, the messages may be relayed between the participants by the messaging service, or the messaging service may provide network address information to allow the participant to exchange the messages with each other directly.

It can also provide enhanced communication functions within messaging groups, such as the communication of interactive content (polls, surveys, meeting invites, job assignments etc.), rich content (audio data, image data, file sharing etc.). Interactive content is also referred to herein as “cards”, referring to the fact that options relating to the interactive content may be displayed on a card-like interface.

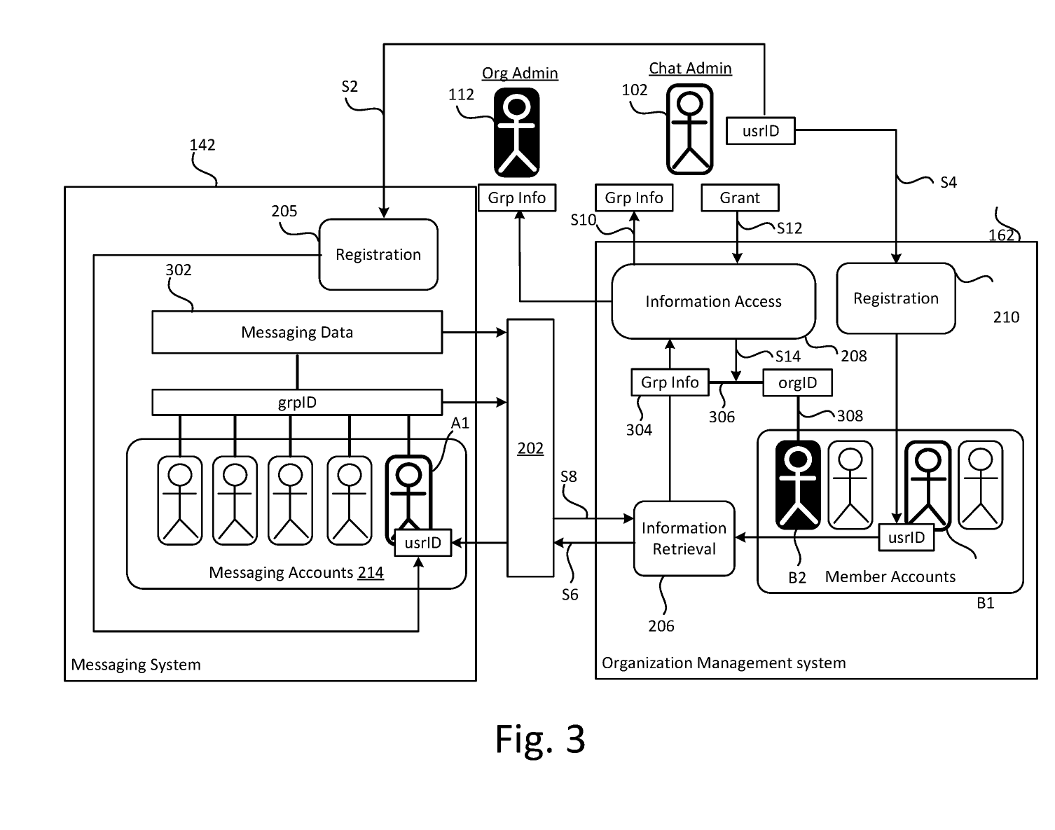

At least part of the data communicated between the group and/or at least one metric derived therefrom is stored at the messaging system in association with the group ID (as data 302, in FIG. 3).

As noted, the organizational management system 162 provides one or more organization management services 212, to assist its users in managing their (respective) organization(s). That is, in some implementations the services 212 may be provided to a plurality of different organizations, identified by respective organization IDs 226 held in the second computer storage 166.

Such services 212 can for example include email services, e.g. business email, document sharing and collaboration, shared storage, and the provision of application software, such as word processing software, spreadsheet software etc. An example of an organizational account providing such services is O365. Organizational accounts and the types of management services 212 they can provide are known in the art, and are not discussed in further detail herein.

Both registration services 205, 210 allow a user to register an (external) user identifier with his messaging account 214 and member account 224 respectively. Once registered thus, both the user's messaging account 214 and his member account 224 comprise a version of that same user identifier. That is, the accounts comprising matching user identifiers, which can be used by the system interface 202 to link them together.

The user ID is a telephone number in the described examples, but could be another form of external ID such as an email address. The user ID is external in the sense that it is semantically meaningful outside of the systems 142, 162, and thus constitutes an external identity of the user.

To illustrate this, an example process for importing messaging group information into the organizational system 162 form the messaging system 142 will now be described with reference to FIG. 3.

At step S2, the chat admin 102 creates a messaging account A1 (which is one of the messaging accounts 214) within the messaging system 142, and registers an external user identifier (usrID) with account A1 in the messaging system 142 as described above, such that messaging account A1 comprises the user ID. As part of this, the user 102 provides at least one user credential (e.g. passcode), for use in authenticating himself to the system when he (including she) wishes to access his messaging account A1 later, a version of which is stored in account A1.

At step S4, similarly, the chat admin 102 creates a member account B1 (which is one of the member accounts 224) within the organizational system 162, and registers the same user ID with account B1 in the organizational system 162 as described above, such that account B1 also comprises that same user ID. Similarly, as part of this registration process, the user 102 provides at least one user credential (e.g. passcode), for use in authenticating himself to the system when he wishes to access his member account B1 later, a version of which is stored in account B1.

The registration of the user ID may be conditional on successful verification of the user ID. For example, where the user ID is a telephone number or email address, the registration service 210 may communicate a verification code to that number or address, and the user 102 may be required to correctly identify the verification code to the system 162 in order to register it with the system 162.

Steps S2 and S4 can be performed in any order, or in parallel.

As noted, each of the systems 142, 162 has respective authentication functionality 201,203, wherein the user 102 can authenticate himself to that system in order to access messaging account A1 and member account B1 respectively, and thereby access the various services provided by that system which he is authorized to access.

At step S6, the information retrieval service 206 generates a group information request comprises the user ID as registered with member account B1, which is received by the system interface 202. The group information request can be generated automatically, or in response to a user input, for example an input from the chat admin 102 instigated at device 104.

In response, the system interface 202 uses the user ID in the group information request (S8) to locate messaging account A1, based on the matching ID in messaging account A1. Once located, the system interface 202 then identifies, where possible, at least one messaging group of which the chat admin 102 is a member. That is, where possible, it determines at least one group ID (grpID) associated with his messaging account A1, and based on this locates group messaging data 302 associated with the group ID. That is, data exchanged between users in the messaging group, such as instant messages, interactive content (e.g. relating polls on which group members can vote, surveys conducted within the group, job assignments within the group, meeting invites circulated within in the group and/or customized interactive content), or rich content (image data, audio data, file sharing etc.).

At step S8, the system interface responds to the group information request with group information 304, which can for example comprise (part of) the messaging data 302, one or more metrics derived from the messaging data and/or the group ID.

In this example, an additional requirement is imposed, such that the system interface 202 will only respond with such information for messaging groups that the user 102 is a group administrator of. That is, for which message account Al is assigned a group administrator role in the first computer storage 146. As well as being a participant in a group, the group administrator has access to higher level control functions that are not accessible to regular participants. These functions can vary depending on the context.

The information retrieval service stores the message group information 304 in the second computer storage of the organizational system 162, such that it is accessible to the information access service 208.

Where the chat admin 102 is a group admin for multiple messaging group, information for each of those groups is returned and stored thus.

The chat administrator 102, whilst authenticated to organizational system 162 based on the credential information in his member account B1, can access the retrieved group information 304 via the information access service 208 (S10).

As well as accessing the group information 304 himself, he can selectively grant access (S12) to said information, so that other member(s) of his organization can also access some or all this information 304. For example, the chat admin 102 can allow access to information about a specific group or groups only.

In response to the grant of access for a particular messaging group, the information access component 208 associates (S14) the group information 304 for that group with the organization identifier 226 of the organization to which the chat admin is grating access, by creating an association 306 between that information 304 and the organization ID in the second computer storage 166.

This does not allow every member of the organization to access that information, but it does allow any organizational admin for that organization to access it. At least one of the member accounts 224 is configured as an organizational admin account (account B2 in FIG. 3, belonging to the org admin 112), and there exists an association 308 in the second computer storage 166 between the organization identifier of that organization and the org admin account B2.

Based on these associations 306, 308, the information access service allows the org admin 112 to access the (part of) the group info 304 held at the organization management system 162, provided he is authenticated to the system 162 using the user credential information held in his account B2.

The information can for example be outputted to the org admin 112 as a report generated by the information access service 208.

As will be apparent, this process of FIG. 3 allows chat group admins to link their chat groups into org subscription system 162.

This ability is about being able to link the groups by a particular group admin to his organization. The approach is to provide an option for the admin 102 to select which group(s), form the groups that he is part of, that should roll up to the selected organization, by associating it with its organization ID, and which ought to be omitted out from organizational reporting.

For the org admin 112 to have a complete overview of group information across the organization, multiple chat admins need to grant access to groups they are admins in the same manner.

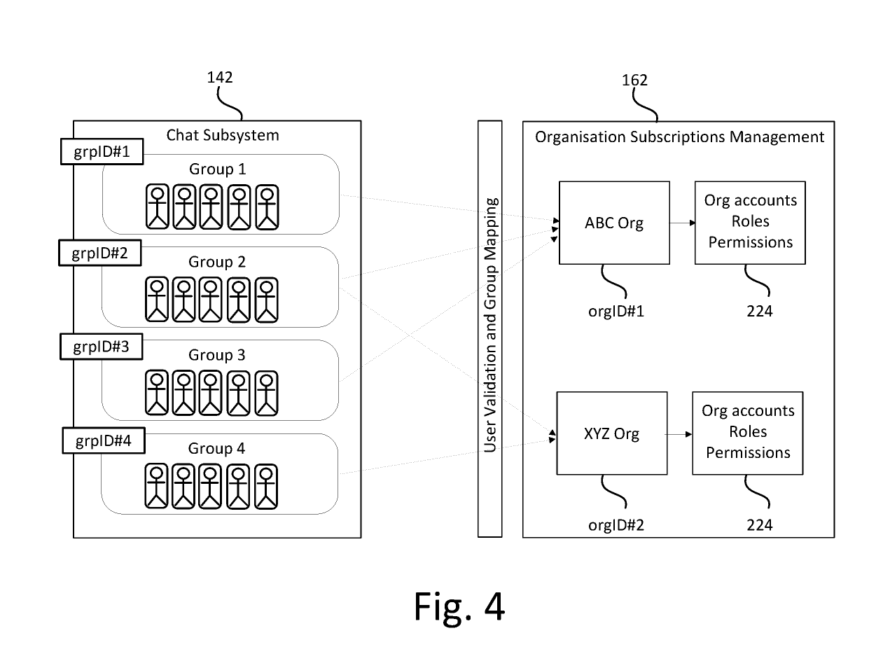

This is illustrated in FIG. 4, which also shown how chat admins can be members of multiple organizations (org IDs: orgID#1, orgID#2), such that they can associate a given group they are admin of with one of multiple organizations. Four groups (group IDs: grpID#1, grpID#2, grpID#3, grpID#4) are shown purely by way of example.

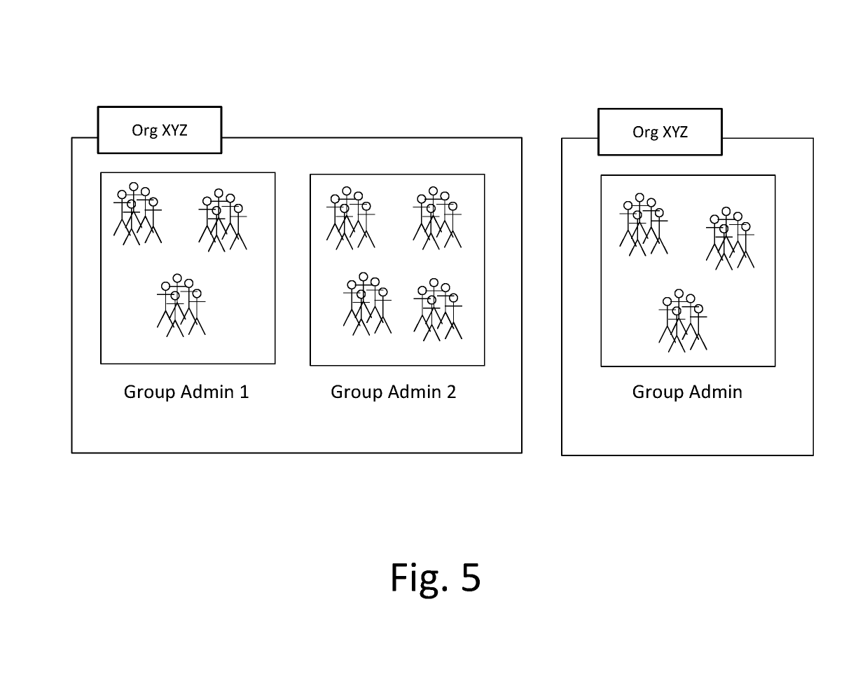

As shown in FIG. 5, for a given org, there can be multiple admins who are responsible for different groups (e.g. departments). The linking is defined as via Organization ->Group admins ->Groups.

In case of group of groups defined within the messaging system 142, once a parent group is mapped to an organization (that is, to its organization ID), all the child groups are automatically mapped to the organization ID.

The information retrieval service may implement (implicit) derivation of groups at organization level: An admin 102 maps subset of his groups to the organization. However, since there could be multiple admins across departments within an org, duplicate information may be provided to the messaging system 162 inadvertently. The list of unique groups for the organization can implicitly be derived at the organizational system 162.

Based on the group information 304 returned to chat admins across the organization, the org admin 112 can view data aggregations defined by organization boundary. That is, aggregated information generated by aggregating information associated with the organization ID of his organization.

The aggregated data, for example a number of documents, photos, etc. exchanged within the group, can be aggregated from across the groups to provide a consolidated view for group admins as well as to the set of tenant admins. While it is possible to do so with few other approaches like just allow selecting the groups at runtime to see aggregated data, this approach makes it possible to reuse these mappings across the org.

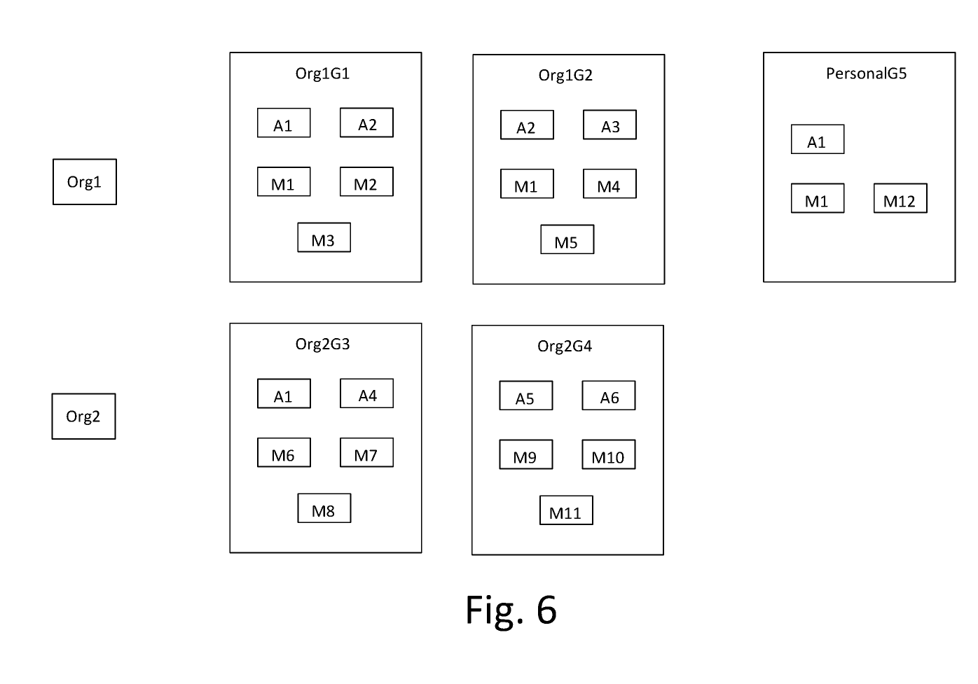

To further assist illustration, an example use-case will now be described with reference to FIG. 6. In this example, there are two organizations: Org1, Org2. Org1 has two groups: Org1G1 and Org1G2. Org2 has two groups Org2G3 and Org2G4. Each group has admins (A*) and normal members (M*), are shown in the FIG. 6. A personal group PersonalG5 is also shown, which is not related to any particular organization.

The admins can select the groups that are related to their organization in organizational system 162, e.g. Office 365 organization, with their respective member account 224, e.g. Office 365 account. E.g. A1 or A2 will map Org1G1 to Org Org1. Similarly, other admins will map respective groups to the respective orgs. However, no one will map personal group PersonalG5 to any org, hence its data will not be visible (or roll up) in any of the reports.

Organization admin for Org1 will have visibility into both Org1G1 and Org1G2, by virtue of other chat admins in the org mapping their respective groups to the organization. Admin A1 may belong to multiple orgs e.g. in the example below A1 can map another group Org2G3 to Org2.

Admin A1 will have two separate member accounts (e.g. O365 accounts) in the organizational system 162 and will see respective groups with respective office account. That is, one member account for each organization they are a member of.

In this example, member M1 is part of 3 groups: an org group Org1G1 and a personal group PersonalG5. While any messages/cards in group Org1G1 and Org1G2 will show up in Org1 reporting, none of the cards in PersonalG5 will show up in any org reporting.

This described technology provides dynamically linking independent chat groups created in a chat subsystem 142 to an organization entity that is defined and managed in a separate organizations subscription system 162.

In present existing systems, first the organization is defined, to which groups are then tightly coupled at creation time (that is, when the group is created). The primary reason for keeping the links (or mapping) outside is to abstract the organization setup related flows and other details from the chat application and avoid bringing additional complexity for end users. Users prefer the simplicity of familiar chat apps where they see simple groups (including one-to-one conversations, and larger groups) but as large organizations adopt the same chat app for business purposes, it brings many enterprise scenarios/requirements for analytics on the aggregated data across the chat groups (but within their org. boundary) that remain unlinked in the app. The requirement exists only for the subset of users i.e. administrators 102, 112 rather than for each user. The dynamic linking approach enables desired capabilities in a loosely coupled manner. Some example powerful scenarios include being able to perform correlated and aggregated computing, business intelligence and reporting at organization level in the backend, even though the linked groups remain independent otherwise.

Note references to software executed on at least one processor (or similar) can mean all of the software are executed on the same processor, or that portions of the code can be executed on different processors, which may or may not be collocated. For example, in the example architecture of FIGS. 1 to 3, the various services described above can be individually implemented on one more multiple processors, for example embodied in one or more servers; different services can be implemented on the same processor(s)/server(s) or on different processors/servers. In practice, different code portions may be implemented on different processors at different locations, possibly in different data centres which can communicate via the network 108 or a dedicated back-end connection, for example. Note also that “computer storage” refers generally to one or more computer-readable storage devices, such as magnetic or solid-state storage devices. For multiple devices, there may or may not be spatially collocated. For example, different parts of the first/second computer storage 146, 166 may likewise be implemented at different data centres, for example. The system code can be stored for execution at the system in question in one or more computer readable memory devices. The features of the techniques described herein are platform-independent, meaning that the techniques may be implemented on a variety of commercial computing platforms having a variety of processors. For example, the systems may include a computer-readable medium that may be configured to maintain instructions that cause the systems, and more particularly any operating system executed thereon and associated hardware of the system to perform operations. Thus, the instructions function to configure the operating system and associated hardware to perform the operations and in this way result in transformation of the operating system and associated hardware to perform functions. The instructions may be provided by the computer-readable medium to the system processor(s) through a variety of different configurations. One such configuration of a computer-readable medium is signal bearing medium and thus is configured to transmit the instructions (e.g. as a carrier wave) to the computing device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer system comprising:
a messaging system comprising: (i) first computer storage holding messaging accounts for users of the messaging system, and (ii) a group messaging service configured for use in transmitting and receiving messages via a network between users in each of plurality of messaging groups, those users having messaging accounts associated with that messaging group in the first computer storage;
an organization management system comprising: (i) second computer storage holding member accounts for members of an organization, and (ii) a registration service for registering user identifiers with the member accounts in the second computer storage; and
a system interface for communicating information between the messaging system and the organization management system;
wherein an information retrieval service of the organization management system is configured to generate a group information request comprising a user identifier registered with one of the member accounts; and
wherein the system interface is configured to communicate to the organization management system, in response to the group information request, information about at least one of the messaging groups associated with a corresponding one of the messaging accounts comprising a matching user identifier.

2. The computer system according to claim 1, wherein a different one of the member accounts is configured as an organisation administrator account in the second computer storage;
wherein an information access service of the organization management system is configured to grant, to an authorised user of the organisation administrator account, access to the messaging group information retrieved for the member account.

3. The computer system according to claim 2, wherein the information access service is configured to:
communicate to an authorized user of the member account the group messaging information retrieved for the messaging group,
receive from the user of the member account a grant of access for the messaging group, wherein said access to the messaging group information is granted to the user of the organization administrator account in response.

4. The computer system according to claim 3, wherein the organization administrator account is associated with an organization identifier in the second computer storage, and the grant of access associates the messaging group with that organization identifier in the second computer storage, thereby granting said access to the user of the organization administrator account.

5. The computer system according to claim 2, wherein the user of the organisation administrator account is granted access to messaging group information retrieved from the messaging system for a plurality of messaging groups, each associated with a messaging account in the messaging system corresponding to a member account in the organization management system.

6. The computer system according to claim 4, wherein the user of the organisation administrator account is granted access to messaging group information retrieved from the messaging system for a plurality of messaging groups, each associated with a messaging account in the messaging system corresponding to a member account in the organization management system;
wherein each of the plurality of messaging groups is associated with the organization identifier in the organization management system, thereby granting the user of the organisation administrator account access to the information about those messaging groups.

7. The computer system according to claim 1, wherein the information access service is configured to cause a display accessible to an authorized user of the member account to display the group messaging information retrieved for the corresponding messaging account.

8. The computer system according to claim 1, wherein the communication, by the system interface, of the information about the messaging group associated with the corresponding messaging account is conditional on that messaging account being assigned a group administrator role for the messaging group within the messaging system.

9. The computer system according to claim 1, wherein the user identifier comprises a telephone number and/or an email address.

10. The computer system according to claim 1, wherein the information retrieval service is configured to:
retrieve messaging group information from the messaging system for at least two of the member accounts in the second computer storage of the organization management system,
determine therefrom that corresponding messaging accounts in the first computer storage of the messaging system are associated with the same messaging group.

11. The computer system according to claim 10, wherein the at least two member accounts are associated with the same messaging group in the messaging system such that duplicate information is communicated to the organization management system for that messaging group by the system interface, wherein the organization management system is configured to detect and remove the duplicate information.

12. The computer system according to claim 1, wherein the retrieved information comprises a messaging group identifier for the messaging group.

13. The computer system according to claim 1, wherein the retrieved information comprises message data exchanged between the users of the messaging system in the messaging groups and/or at least one metric pertaining to the exchanged message data.

14. The computer system according to claim 1, wherein the messaging system is configured to provide an authentication function for authenticating users of the messaging system based on user credential information in the messaging accounts, wherein the organization management system is configured to provide a separate and independent authentication function for authenticating users of the organization management system based on user credential information in the member accounts.

15. A computer-implemented method of exchanging information in a computer system between a messaging system and a group management system of the computer system, wherein the messaging system comprises: (i) first computer storage holding messaging accounts for users of the messaging system, and (ii) a group messaging service configured for use in transmitting and receiving messages via a network between users in each of plurality of messaging groups, those users having messaging accounts associated with that messaging group in the first computer storage, wherein the organization management system comprises: (i) second computer storage holding member accounts for members of an organization, and (ii) a registration service for registering user identifiers with the member accounts in the second computer storage, the method comprising
generating, by an information retrieval service of the organization management system, a group information request comprising a user identifier registered with one of the member accounts; and
in response to the group information request, communicating to the organization management system, by a system interface of the computer system, information about at least one of the messaging groups associated with a corresponding one of the messaging accounts comprising a matching user identifier.

16. The method according to claim 15, wherein a different one of the member accounts is configured as an organisation administrator account in the second computer storage, wherein an information access service of the organization management system grants, to an authorised user of the organisation administrator account, access to the messaging group information retrieved for the member account.

17. The method according to claim 16, wherein the information access service communicates to an authorized user of the member account the group messaging information retrieved for the messaging group, and receives from the user of the member account a grant of access for the messaging group, wherein said access to the messaging group information is granted to the user of the organization administrator account in response.

18. The method according to claim 17, wherein the organization administrator account is associated with an organization identifier in the second computer storage, and the grant of access associates the messaging group with that organization identifier in the second computer storage, thereby granting said access to the user of the organization administrator account.

19. The method according to claim 15, wherein the user of the organisation administrator account is granted access to messaging group information retrieved from the messaging system for a plurality of messaging groups, each associated with a messaging account in the messaging system corresponding to a member account in the organization management system.

20. The method according to claim 15, wherein the user identifier comprises one or more of a telephone number or an email address.
